(19) United States
(12) Patent Application Publication
(10) Pub. No.: US 2003/0138124 A1
(43) Pub. Date: Jul. 24, 2003

(54) Floral or gift display with remote voice or sound recording and playback capability

(76) Inventor: Rosa Rivera, Brooklyn, NY (US)

Correspondence Address: DONN K. HARMS, PATENT & TRADEMARK LAW CENTER, SUITE 100, 12702 VIA CORTINA, DEL MAR, CA, 92014, US

(21) Appl. No.: 10/053,804

(22) Filed: Jan. 24, 2002

(51) Int. Cl. G11B 5/02; H04R 5/02; H04R 1/02; H04R 9/06

(52) U.S. Cl. 381/388; 360/55; 381/301; 381/333

(57) ABSTRACT

An assembleable recording and playback device for assembly and cooperative engagement in combination with a display unit for gifts such as vase providing a more personalized presentation for flowers and gifts from givers to receiving parties. The device features a plurality of recording and playback units which cooperatively engage with a plurality of different functional and ornamental display units such as vases and gift boxes. From a remote location, a person may call and record a personal message which is placed on the appropriate recording and playing device which is then cooperatively engaged with the appropriate ornamental display unit such as a vase. The assembled device can then be delivered with flowers or their gift anywhere in the world on the same day it is ordered with the personal message which plays when a drawer is opened. This new and unique invention also offers a means whereby individuals may record personal messages which will be placed in memory of a playback unit through an electronic interface to a telephone or microphone allowing for remote recording from distant locations.

### FIELD OF THE INVENTION

This invention relates to a device for delivery of personalized messages and sound recordings. More particularly it relates to a device that can be configured for incorporation into the vase holding flower arrangements, ornaments, figurines or other similar items which may be enhanced by adding music, a recorded jingle or a personal message. Additionally, a personal compartment for storage of small articles can be added to enhance the device's utility. This device can be housed within an enclosure inserted in a cutout in the containment means, or may be housed within a separate display unit with the item being displayed sitting on top. In use in this fashion, the device will enhance and personalize flower arrangements, gifts and keepsakes in a new and unique method where a personal recorded message can be transmitted by telephone anywhere in the world, to be recorded and played on the device the same day.

### BACKGROUND OF THE INVENTION

This invention describes a new and unique device and method to enhance and personalize gifts from one party to another. Such gifts are most commonly flowers that are usually given with greeting cards having generic messages but lacking a personalized message from the giver. The enhancement of music or the personalization of comments in the voice of the individual through a local or remote interface with a recording device is provided by the device herein disclosed.

The florist industry alone, where arrangements are ordered and delivered all over the world, has no means of personalizing their deliveries other than the greeting cards. Such cards delivered with the flower arrangement, unusually are filled out by a florist store employee based on the phone call from the giver. Although the greeting card industry has developed greeting cards with recorded music and jingles, they do not have the recording capability to record the giver's own voice and message in that voice. Differing from the common music box, this invention has the capability of offering a number of different options from a simple voice recording, music, a recorded jingle, or the unique feature of a personal message alone or in combination with the other sounds that can be recorded over the telephone from anywhere in the world. An added benefit of this device is the longevity of the recorded message and that it may be played over and over again for many years, each time bringing the gift to the memory of the receiver.

When used as a slide in drawer style device, mementos and family keepsakes from relatives or friends may be placed in or on top of these devices with a personalized recording of their voice describing the article to be kept for years after their passing, when these items and recordings will become irreplaceable.

U.S. Pat. No. 3,256,953 of John J. Rimi This invention is directed toward flowerpots containing loudspeakers whereby sounds and music can be emitted therefrom. This invention relates to a speaker decorated as a flowerpot that would have to be connected to a conventional sound system. This invention could not be used as a gift and does not have an internal recording capability.

U.S. Pat. No. 5,389,030 of Stephen Chapkis describes a novelty device for inflating an inflatable element such as a balloon. This is a unique novelty device, but does not incorporate the features of display or of recording and playing back personal messages.

U.S. Pat. No. 5,547,721 of Hsin H. Kuo describes a unique vase with two separate chambers so that flowers with water can be put in the top section and the bottom chamber is dry and may contain either, a scent or light emitting element. Although this vase may be given as a gift it does not fulfill the feature of the recorded message, and does not have the capability of being a display device for mementos or family keepsakes.

U.S. Pat. No. 5,624,320 of Benjimin P. Martenez teaches of a person-to-person flower presentation package. A conical open-topped container with a cord at the bottom is presented as a gift. Upon presentation the cord is pulled and the flowers rise up and there is one or more popping sounds. This is a unique, trick gift item, but it offers no real lasting ornamentation that can be saved or displayed.

U.S. Pat. No. 5,995,958 of Kai Lu describes a candy jar that looks like a normal candy jar, but when someone tries to get some candy from it, it will make a special sound and produce lighting. This device will require motion sensors, lighting circuitry and a sound playing capability, but lacks the unique feature of being able to be used to display articles and record personal messages to be played back when desired as disclosed within this invention.

U.S. Pat. No. 6,038,812 of Paul Belokin, et al, discloses a vase or similar container, which includes a display support for an electric motor for driving an active display. This invention describes a device of adornment for flowers in a vase, but does not include a recording device to play a prerecorded message.

U.S. Pat. No. 6,112,442 of Dennis Liang teaches of a gift box whereby a flower will rise from the decoration container, and music will be produced through a loud speaker when the keyboard is operated. Although this device has the playing capability, it does not have the recording capability and would not be convenient for florists throughout the world to keep in stock for a relatively inexpensive addition to personalize their products.

U.S. Pat. No. 6,158,588 describes a gift product package that is comprised of a rugged exterior carton designed for concealing a gift, with a recordable sound module and an inflation device that causes a small gas canister to fill a large balloon and to eject confetti. This invention has the recording capability but has been designed as a unique gift in itself, not intended for a lasting device for displaying flower arrangements, ornaments, figurines or other similar items.

The invention accordingly comprises the features of construction, combination of elements, and arrangement of parts that will be exemplified in the construction hereinafter set forth, and the scope of the invention will be indicated in the claims.

### SUMMARY OF THE INVENTION

The present invention accomplishes its desired objects by creating a device that can be used in several different ways to accomplish the task of enhancing a gift and retaining a personalized recording. The preferred embodiment of this invention will have an enclosure for the device to be inserted through a rectangular orifice in a containment vessel, which in a preferred embodiment would be a vase for flowers. A retainer will be placed over the enclosure from the inside to hold the enclosure in position. If the vessel is to hold live flowers, a watertight chamber will be created above the device and holding chamber. The device will be configured as, but is not limited to, a drawer that will slide within the enclosure with the recorder/player in the front portion to be secured by threading the pull knob through the faceplate and a spacer if required. The recorded message would be activated by pulling out the drawer member, but would additionally have on/off/play and record buttons. The recording device will have a speaker and microphone and micro switch for activation of the message and will also have the capability of recording the message on a small tape or conventional chip. The drawer shaped favored embodiment will have a compartment that can hold small articles or gifts.

An alternate embodiment of the device will be a unit that will contain a drawer with the recorder/player but will have no cavity for holding small articles, thus having a lower profile. This embodiment will have the displayed item either attached to or resting on top of the device.

Another embodiment of the device will have a unit with a drawer with the recorder/player and a compartment for holding small articles. This embodiment will have the displayed item either attached to or resting on top of the device.

In the best current mode of the device, all of the embodiments of the device would be configured to cooperatively engage with a standard dimensioned compartment that would be in the vessel holding it. In that fashion, florists and other sellers of the device would be able to allow buyers to choose from a large variety of vessels for the flowers or gift with each being configured with a compartment to cooperatively engage with one of a plurality of the devices that would be loaded with music and/or using an electronic interface such as a microphone or attachment to the telephone the giver's voice and/or some sort of personalized message could be placed in the electonic memory of the recording device. This interchangeability in essentially a kit form of a plurality of different vessels all configured to cooperatively engage a plurality of the disclosed recording devices would allow great flexibility to the seller and buyer alike as to the degree of personalization of the gift sent to the receiving party.

It is an object of this invention is to supply a vase or similar device that will have a component capable of storing and delivering a recorded message to enhance a gift.

Another object of this invention is to supply a device that can be inserted into one or a plurality of cooperatively dimensioned containers to supply a recorded message.

Another object of this invention is to supply a device that will have a recorded message and will insert into and conform to the exterior features of the container.

A further object of the invention is supplying a device insertable into a plurality of different holders that along with a personal recorded message will have the option of having a compartment for storing additional small articles therein.

Another object of this invention is to supply a device that can be placed under an article to be displayed and will have a recorded message.

Still another object of this invention is to supply a device that will personalize gifts with the voice of the person giving the item to be delivered to another person anywhere in the world the same day using an electronic interface to record the voice on the playback device.

A still further object of this invention is to supply a device that will retain a personalized message from the giver that can be kept for many years.

These together with other objects and advantages which will become subsequently apparent reside in the details of the construction and operation as more fully hereinafter described and claimed, reference being had to the accompanying drawings forming a part hereof, wherein like numerals refer to like parts throughout.

### BRIEF DESCRIPTION OF THE DRAWING FIGURES

The accompanying drawings, which are incorporated in and form a part of this specification, illustrate embodiments of the invention and together with the description, serve to explain the principles of the invention.

FIG. 1 depicts a perspective, exploded view of the preferred embodiment with a vase type of display piece.

FIG. 2 depicts a perspective view an alternate embodiment being but not limited to, a round display unit without a compartment in the drawer.

FIG. 3 depicts a perspective, exploded view of a third embodiment being a square display unit with a compartment in the drawer.

### DETAILED DESCRIPTION OF THE PREFERRED EMBODIMENTS

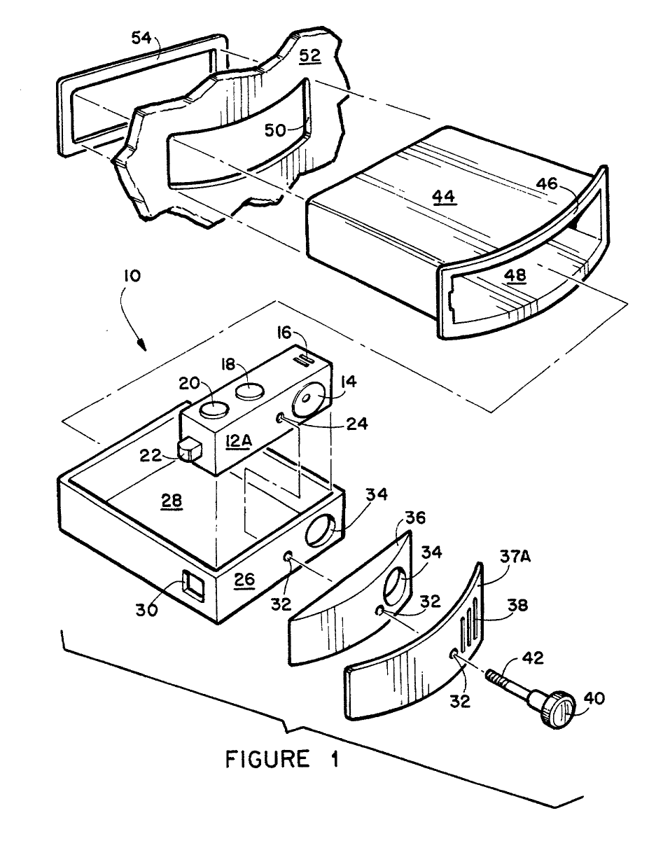

Referring now to FIG. 1 showing a perspective view of the preferred embodiment of the display, recording and playing device 10 in an exploded view with the recording and playing device 12A incorporating a speaker 14, a microphone 16, a record/play button 18, the on/off button 20 and an activating micro switch 22. The recording and playing device 12A is mounted using a means for mounting the playing device in the drawer which in the current best mode is a threaded mounting orifice 24 within a drawer 26. The drawer 26 in the current best mode of the device will have an inner compartment 28 large enough to retain the recording and playing device 12 along with a small gift. A means to activate and play the recording would communicate with the recording and playing device 12 which currently features the side of the drawer having an orifice 30 allowing the activating micro switch 22 to protrude through. This switch would be depressed when the drawer 26 is opened or closed inside the cooperatively dimensioned internal cavity 48 inside the vase 52 or other type of display article. The depression of the switch 22 would send the signal to start and stop the recording.

In the current best mode, in order to facilitate the ability to insert the device 10 into a plurality of different style vases and other displays and have the device appear to be part of the displaying mated component, a means to change the shape of the front of the drawer to conform with the exterior of the displaying unit would be provided which is shown in the current best mode with the front of the drawer 26 having an orifice 32 to align with the threaded mounting orifice 24 in the recording and playing device 12A. An additional orifice 34 aligning with the speaker 14 is provided to allow for sound travel. Depending upon the shape of the container, an optional spacer 36 may be required, with a mounting orifice 32 and an orifice 34 aligning with the speaker 14. The front of the faceplate 37 would be dimensioned to match the adjoining surfaces around the faceplate when the device 10 is mounted. This adaptability is depicted by the curved faceplate 37 shown matching the curvature of the front of the vase 52 or similar display unit and if needed the spacer 36 would add sufficient thickness for a flush mating with adjoining surfaces and in line mounting with the mounting orifice 32 and a speaker grill 38. When pull knob 40, with its threaded shaft 42, is inserted through the mounting orifices 32 into the threaded mounting orifice 24 of the recording and playing device 12A and tightened securely, all the parts will be held in place and the front surface 33 of the faceplate 37A would match the surface shape of the vase 52 or similar holder.

In a preferred embodiment the assembled drawer 26 slides within the internal cavity 48 of the drawer enclosure 44 and will activate the mechanism by means of the micro switch 22 when the drawer 26 is extracted. The drawer enclosure in the preferred mode will have a flange 46 around the periphery of the internal cavity 48. The drawer 26 and drawer enclosure 44 will slide through a cutout 50 in the display piece 52, to be held by the retainer 54. However, the enclosure 44 could also be molded into the vase 52 or other display with equal utility being provided.

The enclosure 44 may be molded into and combined with the vase 52 or slid into a cutout 50 formed in the vase 52 if it is dimensioned to cooperatively engage with a plurality of different drawers 26 the seller and the buyer would thereby be able to choose from a kit of the different recording and playing devices 10 each with the same drawer 26 configuration and each cooperatively engageable with the enclosure 44. A particularly preferred embodiment of the disclosed device herein would be a vase 52 having a water holding compartment (not shown) and the separate drawer enclosure 44 with a waterproof internal cavity 48 being formed therein. As the device contains electronics, the waterproof internal cavity 48 would be required. Of course the faceplate 37A would be dimensioned to match the curve and color and texture of the adjacent vase 52.

This would enable sellers to have prerecorded music or background music on the playing devices 10 and insert them into one or a plurality of differently ornamentally designed vases 52 or other holders. The buyer thus could choose from a wide variety of enclosing display units such different ornamental vases 52 or square display units 68B or round display units 68A and thus give buyers a menu of different music, voice, and display options which can then be assembled from the kits of display units and playing devices 10 to meet the buyer's desire for custom messaging and ornamental design.

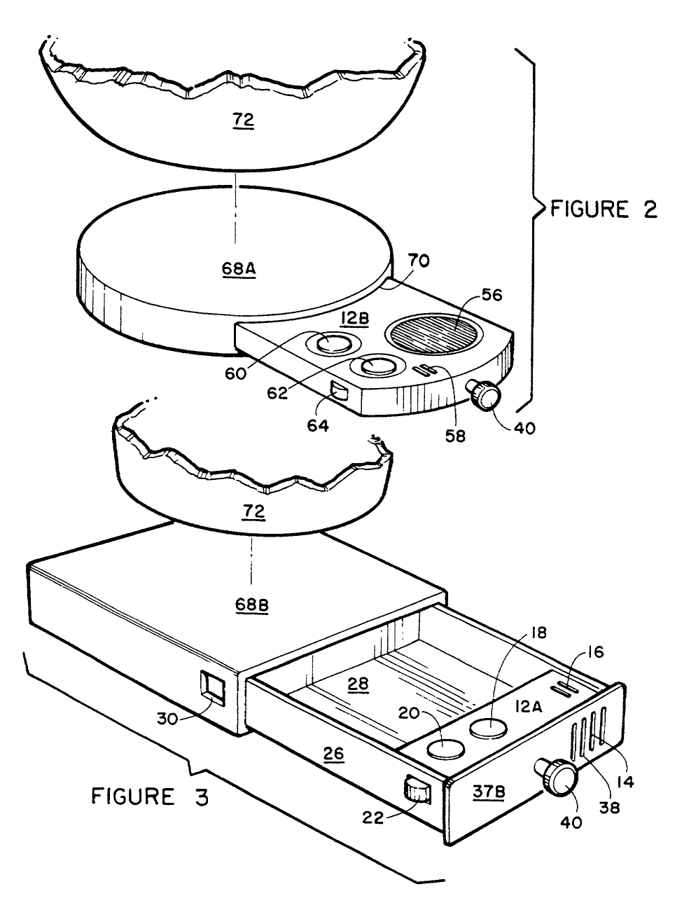

FIG. 2 illustrates an alternate embodiment of the recording and playing device 12B, being a sealed unit with no compartment 28 as in the previous embodiment 12A. This playing and recording device 12B will be comprised of a speaker 56, microphone 58, a play/record button 60, an on/off button 62 and an activating micro switch 64. This device will incorporate the same pull knob 40 as drawer 26 in FIG. 1. The playing recording device 12B will slide within the inner cavity 70 of the display unit 68A. Although FIG. 2 illustrates the display unit 68A as a circular piece, it must understood that any ornamental or geometric shape with a flat surface to rest a display article 72 on top is anticipated within the scope of this patent.

FIG. 3 illustrates a second alternate embodiment of the display unit 68B, being a square unit with a drawer 26, and the compartment 28 similar to those illustrated in FIG. 1. The recording and playing device 12A with the speaker 14, the microphone 16, the record/play button 18, the on/off button 20 and activating micro switch 22, is shown with a flat front faceplate 37B having speaker grill 38 and pull knob 40.

As noted, messages may be recorded to the memory of the playing device 10 by the buyer in their own voice over an electonic interface (not shown) between the memory of the playing device and the telephone or a microphone in person, thus giving the gift great personal meaning. Such conventional electronic interfaces attach to the analog or digital phone and shunt the voice from the speaker through the interface to the memory of the playback device. By having kits with a plurality of ornamental designed vases 52 or other display units of different shapes and sizes each having an internal cavity 48 dimensioned to cooperatively engage a plurality of drawers 26 with different recording and prerecorded messages and sound, great utility is provided to the buyers of gifts such as flowers or jewelry or other presents in being able to assemble a very personal package from a long distance. The buyer would simply choose and/or record the message to the appropriate recording and playing device 10 which would be configured to cooperatively engage the internal cavity 48 a plurality of ornamental vases 52 and display units that the buyer may choose from. Once the components are so chosen by the buyer, a seller such as a florist would assemble the components from the kit of display units and the plurality of recording and playing devices 10 and send out a very personal message from the buyer in sound as well as ornamental design.

While the present invention has been described herein with reference to particular embodiments thereof, a latitude of modification, various changes and substitutions are intended in the foregoing disclosure, and it will be appreciated that in some instance some of the features will be employed without a corresponding use of other features without departing from the scope of the invention set forth.

What is claimed is:

1. An improved display unit for gifts comprising:
an electronic sound playback device having a memory for storage of electronically recorded sound and a switch activated sound playing component for playing said recorded sound;
said electronic sound playback device mounted in a drawer, said drawer cooperatively engageable within an internal cavity of display unit and moveable from a retracted position inside said internal cavity to an open position protruding from said internal cavity; and
said switch activating said sound playback device to play said recorded sound when said drawer is moved to said protruding position from said retracted position.

2. An improved vase with recordable sound and messages for storage and display of flowers comprising:
said vase having a fluid holding cavity having an open end communicating with the exterior of said vase;
an electonic sound playback device having a memory for storage of electronically recorded sound and a switch activated sound playing component for playing said recorded sound;
an internal cavity formed in said vase with an entry aperture providing access thereto through an exterior surface of said vase;
said electronic sound playback device mounted in a drawer, said drawer cooperatively engageable through said entry aperture and within said internal cavity of said vase and moveable from a retracted position inside said internal cavity to an open position protruding from said entry aperture; and
said switch activating said sound playback device to play said recorded sound when said drawer is moved to said protruding position from said retracted position.

3. The improved vase of claim 2 additionally comprising:
said drawer having a front end visible from the exterior of said vase when said drawer is in said retracted position; and
a kit of faceplates each configured on a first side surface for cooperative engagement on said front end and each having a second side surface conforming to the shape of the exterior surface of said vase adjacent to said entry aperture when said drawer is in said retracted position.

4. The improved vase of claim 3 wherein said vase is a chosen vase from a kit of a plurality of different shaped vases and said kit of faceplates has individual faceplates from which at least one faceplate is attachable to said front end of said drawer on said first side surface and has a second side surface conforming to the shape of the exterior surface of said chosen vase adjacent to said entry aperture when said drawer is in said retracted position thereby allowing said improved vase to be assembled from a kit of vases all having said internal cavity cooperatively engageable with said drawer and a kit of faceplates attachable to said drawer.

5. The improved vase of claim 4 wherein said electronic sound playback device mounted in a drawer is one of a kit of said electronic sound playback devices each mounted in one of said drawer thereby allowing thereby allowing said improved vase to be assembled from one of a kit of said electronic sound playback devices each mounted in a drawer and one of a kit of vases all having said internal cavity cooperatively engageable with said drawer and one of a kit of faceplates attachable to said drawer.

6. The improved vase of claim 2 wherein said electronic sound playback device mounted in a drawer is one of a kit of said electronic sound playback devices each mounted in one of said drawer wherein each of said kit of said electronic sound playback devices each mounted in a drawer is recordable with different sounds through a remote interface thereby allowing assembly of said improved vase with one of a plurality of sounds transmitted from said interface to said memory of said electronic sound playback device and that may be played when said drawer is moved to said protruding position.

7. The improved vase of claim 6 wherein said sounds recorded to through said remote interface is a human voice thereby allowing assembly of said improved vase with a personal message from a human being transmitted from said interface to said memory of said electronic sound playback device and that may be played when said drawer is moved to said protruding position.

8. The improved vase of claim 7 wherein said remote interface allows recording sound from a telephone to said memory of said electronic sound playback device thereby allowing said message from a human being to be recorded from a distant location to said memory played when said drawer is moved to said protruding position.

9. The improved vase of claim 3 wherein said electronic sound playback device mounted in a drawer is one of a kit of said electronic sound playback devices each mounted in one of said drawer wherein each of said kit of said electronic sound playback devices each mounted in a drawer is recordable with different sounds through a remote interface thereby allowing assembly of said improved vase with one of a plurality of sounds transmitted from said interface to said memory of said electronic sound playback device and that may be played when said drawer is moved to said protruding position.

10. The improved vase of claim 9 wherein said sounds recorded to through said remote interface is a human voice thereby allowing assembly of said improved vase with a personal message from a human being transmitted from said interface to said memory of said electronic sound playback device and that may be played when said drawer is moved to said protruding position.

11. The improved vase of claim 4 wherein said electronic sound playback device mounted in a drawer is one of a kit of said electronic sound playback devices each mounted in one of said drawer wherein each of said kit of said electronic sound playback devices each mounted in a drawer is recordable with different sounds through a remote interface thereby allowing assembly of said improved vase with one of a plurality of sounds transmitted from said interface to said memory of said electronic sound playback device and that may be played when said drawer is moved to said protruding position.

12. The improved vase of claim 11 wherein said sounds recorded to through said remote interface is a human voice thereby allowing assembly of said improved vase with a personal message from a human being transmitted from said interface to said memory of said electronic sound playback device and that may be played when said drawer is moved to said protruding position.

13. The improved vase of claim 5 wherein each of said kit of said electronic sound playback devices each mounted in a drawer is prerecorded with different sounds thereby allowing assembly of said improved vase with one of a plurality of prerecorded sounds that may be played when said drawer is moved to said protruding position.

14. An improved display unit for gifts comprising:
an electonic sound playback device having a memory for storage of electronically recorded sound and a switch activated sound playing component for playing said recorded sound;
said electronic sound playback device mounted in a drawer, said drawer cooperatively engageable within an internal cavity of display unit and moveable from a retracted position inside said internal cavity to an open position protruding from said internal cavity;
said switch activating said sound playback device to play said recorded sound when said drawer is moved to said protruding position from said retracted position.
said internal cavity formed in said display unit having an entry aperture providing access thereto through an exterior surface of said display unit; and
said switch activating said sound playback device to play said recorded sound when said drawer is moved to said protruding position from said retracted position.

15. The improved display unit of claim 14 additionally comprising:
said drawer having a front end visible from the exterior of said display unit when said drawer is in said retracted position; and
a kit of faceplates each configured on a first side surface for cooperative engagement on said front end and each having a second side surface conforming to the shape of the exterior surface of said display unit adjacent to said entry aperture when said drawer is in said retracted position.

16. The improved display unit of claim 15 wherein said display unit is a chosen vase from a kit of a plurality of different shaped display units and said kit of faceplates has individual faceplates from which at least one faceplate is attachable to said front end of said drawer on said first side surface and has a second side surface conforming to the shape of the exterior surface of said chosen display unit adjacent to said entry aperture when said drawer is in said retracted position thereby allowing said improved display unit to be assembled from a kit of display units all having said internal cavity cooperatively engageable with said drawer and a kit of faceplates attachable to said drawer.

17. The improved vase of claim 16 wherein said electronic sound playback device mounted in a drawer is one of a kit of said electronic sound playback devices each mounted in one of said drawer thereby allowing thereby allowing said improved display unit to be assembled from one of a kit of said electronic sound playback devices each mounted in a drawer and one of a kit of display units all having said internal cavity cooperatively engageable with said drawer and one of a kit of faceplates attachable to said drawer.

18. The improved display unit of claim 17 wherein said sounds recorded through said interface is a human voice thereby allowing assembly of said improved vase with a personal message from a human being transmitted from said interface to said memory of said electronic sound playback device and that may be played when said drawer is moved to said protruding position.

19. The improved display unit of claim 17 wherein each of said kit of said electronic sound playback devices each mounted in a drawer is prerecorded with different sounds thereby allowing assembly of said improved display unit with one of a plurality of prerecorded sounds that may be played when said drawer is moved to said protruding position.
